(19) United States
(12) Patent Application Publication
(10) Pub. No.: US 2012/0223102 A1
(43) Pub. Date: Sep. 6, 2012

(54) Attractant scent dispenser for hunting

(76) Inventors: John Edward Ambrose, JR., Severna Park, MD (US); John Edward Ambrose, Severna Park, MD (US)

(21) Appl. No.: 13/506,126

(22) Filed: Mar. 29, 2012

Related U.S. Application Data
(63) Continuation-in-part of application No. 11/205,468, filed on Aug. 18, 2005, now abandoned.

(51) Int. Cl. B67D 7/74

(52) U.S. Cl. 222/145.5

(57) ABSTRACT

A game attracting scent disbursal device for dispersing game attracting scent comprised of a container, a solution of game attractant scent substance and an actuator nozzle. By varying the dimensions of the actuator nozzle and pressure within the container, the scent substance can be disbursed in a foam mass or particulate foam vapor form. The invention solves problems with the present state of the art in that the scent containing substance is free of scent producing contaminates such as acrylic resin, that the scent substance remains flexible, adherent and volatile for several hours and as dispensed in its particulate vapor form can inform the hunter as to the nature of air currents at the hunt site.

### CROSS REFERENCE TO RELATED APPLICATIONS

Continuation-In-Part of application Ser. No. 11/205,468

### STATEMENT REGARDING FEDERALLY SPONSORED RESEARCH OR DEVELOPMENT

Not Applicable.

### REFERENCE TO MICROFICHE

Not Applicable.

### FIELD OF THE INVENTION

Hunting scent attractant substance disbursing device.

The invention is in the field of application and disbursal of game attracting scent substance at a hunt site and the assessment of prevailing air currents as related to the disbursal of scent in the area of the hunt site. The invention accomplishes these two tasks by being disbursed in two forms, specifically a foam mass or as a particulate foam vapor cloud. The invention permits the hunter to apply a resilient and long-lasting game-attracting scent substance at a hunt site in a foam mass to attract game to the hunt site. The invention further permits the attractant scent to be laid down or applied at a hunt site well before the intended time within which the hunter desires to attract the game to the hunt site. The invention also allows the hunter to disburse an attractant particulate foam vapor cloud leading, by way of air currents, to the hunt site while providing a visual test of wind currents and air patterns existing at the hunt site and in the area of the hunt to assist the hunter.

Because of the texture, density and composition of the scent substance in the foam form, the invention has advantages over other scent disbursal systems known in the field. The scent is contained in a foam mass which is adherent and pliant and which does not dry out or become brittle. This feature of the invention allows the foam mass to adhere to the surface upon which it is applied, to remain volatile for a greater length of time. A further advantage of the invention when disbursed in the particulate vapor form is the capability of the scent containing particles to remain aloft and travel with air currents thereby spreading a scent trail leading to the hunt site and informing the hunter of the nature and direction of the air currents at the hunt site. The form of the attractant, either as a foam mass or particulate foam vapor, is achieved by prescribing a particular pressure within the dispenser and prescribing a particular size of the nozzle actuator orifice.

As a result of a function of the pressure within the dispenser and the size and configuration of the nozzle actuator orifice, the scent substance can be disbursed in the particulate foam vapor form as small foam particles, or atomized foam, of size appropriate to allow the particles to float on and be disbursed by air currents but to be of sufficient size to allow the hunter to see the disbursal of the particulate foam vapor particles as they are being carried and disbursed by the air currents. This gives the invention the added feature of allowing the hunter to determine precisely the direction and movement of the air currents around the hunt site to assist the hunter in monitoring game movement.

When dispensed as a foam mass the invention has the feature of permitting the scent substance to remain adherent, flexible and pliant over several hours which prolongs the period of time within which the scent remains volatile and is being disbursed and thus creates a long lasting attractant scent at a hunt site.

The scent substance in its foam mass form also has an adherent nature that permits it to be applied to a tree, rock, ground or other substrate in a manner which prevents the scent substance in its foam form from dispersing rapidly into the ground or atmosphere and thereby losing its attracting properties. This is a distinct and unique advantage over other game attractant scents known in the field. The scent substance in the foam mass form accomplishes this feature by being adherent or sticky enough to cling or attach to variously oriented surfaces. This adhesive character of the scent substance in its foam mass form permits the hunter to apply the scent substance to the underside of tree branches, rocks, logs, vegetation or other objects at the hunt site in a manner to shield the scent substance from rain to prevent rain from quickly washing the scent substance away and thereby losing the effect of the scent, an advantage over the state of the art.

The scent substance disbursed in either its foam mass form or in its particulate foam vapor form further permits the hunter to limit contamination of the site with litter, discarded containers and dispensers and the hunter's own scent and thereby increases the effectiveness of the scent substance. This is another advantage over some of the existing practices in the art which require the container from which the attractant is disbursed to be placed at the hunt site and activated leaving the container at the site. The present invention in use does not require the container to remain at the hunt site. The hunter does not leave the container behind but dispenses the foam mass or particulate foam vapor while retaining the container.

The scent substance is applied by disbursing the scent substance in either the foam mass form or particulate foam vapor form from a pressurized container. This feature of the invention allows the hunter to apply the scent substance without contaminating the hunt site by eliminating a requirement of other devices known in the art that the hunter leave a can, container, cloth or other material at the hunt site. Any method that requires the hunter to leave a can, container, cloth or other material at the hunt site not only has the disadvantage of leaving an object with a repellant scent and the repellant scent of the hunter at the site but also leaves trash and contamination at the hunt site.

### BACKGROUND AND SUMMARY OF THE INVENTION

Hunters have employed various methods and techniques to approach animals without detection and to lure animals within range of the various tools and weapons employed by hunters to provide sustenance and sport. Hunters have known that animals use their sense of smell to detect food, mates and avoid danger. Therefore, it is critical for the successful hunter to be able to determine how scent is being disbursed by the air currents existing at the hunt site and it is helpful to the hunter to attract quarry by taking advantage of attractant scents. It is also well known that the scent of a hunter or predator will repel prey or quarry. A hunter will not be successful if its prey detects the hunter's odor as carried by air currents. A hunter needs to be aware of the air currents and to take position or approach game such that the prey cannot detect the scent of the hunter. In other words, the hunter wants to avoid having the hunter's scent carried by the air currents to the prey. A hunter can at the same time take advantage of the disbursal of an attractant scent that will lure the game to a particular site. Therefore being able to create an attractant scent, being able to determine the direction in which that attractant scent is disbursing and determining a position from which the hunter is within range of the game but not detectable by scent is a great advantage to the hunter.

Animal urine or urine of the intended game, prey or quarry is a well known attractant. It is well known in the art that game, such as deer, are attracted to the scent of deer urine. It is well known that a male deer is particularly attracted to urine of a female deer. It is also well known in the art that a hunter will disperse deer urine in an area into which the hunter desires to attract the quarry and thereafter position him or herself in such a way as to affect capture of the game either permanently, temporarily or photographically. The preferred method of creating such an enticement is for the hunter to collect or obtain a container of deer urine and to dribble or pour the deer urine on the ground, a rock or a tree and to then retreat to the tree stand or blind and to wait for the quarry. Other methods entail the application of the attractant urine to various materials such as cotton wadding. Such items are then placed by the hunter at the hunt site. Other methods entail the disbursal of the scent by the hunter leaving at the hunt site a spray dispenser which the hunter activates and then retreats to the tree stand or blind to wait for the game. Such dispenser does not eliminate the problems caused by leaving the container at the hunt site. These problems include the hunter's scent that remains on the dispenser which necessarily must remain at the hunt site, the scent associated with the dispenser itself and the litter problem created by the un-retrieved scent dispenser.

The present invention overcomes the shortcomings and problems with the present state of the art, improves upon the delivery of scent to the hunt area, and provides the hunter with a way to determine the direction, strength and nature of air currents in the hunt area.

U.S. Pat. No. 6,685,929 describes a non-liquid, non-gel scent lure for hunting comprised of animal urine and a thickening agent. The present invention solves a problem inherent in this prior art in that the present invention provides a means whereby the scent substance is applied to the hunt site in a manner that does not overly contaminate the site with the repellant scent of the hunter and the repellant scent of the scent container. The scent substance of the present invention is superior in its ability to remain adherent and flexible for several hours. The present invention also provides the added feature of providing an effective technique for determining the nature of air currents.

U.S. Pat. No. 6,648,239 describes a device for dispensing animal scents comprised of a cylindrical outer housing, an inner assembly of an absorbent wick for saturation with an attractant. The inner assembly is slidable in and out of the outer housing such that when in the slid out position, the absorbent wick is exposed to air currents. The present invention overcomes the dual shortcomings of this prior art. The present invention does not require the hunter to leave any object at the hunt site. Leaving such items at the hunt site has the disadvantage of littering the hunt site, leaving an object contaminated with the repellant hunter scent from the hunter's handling of the object and the repellant scent of the container itself. The present invention overcomes all of those limitations of the prior art.

U.S. Pat. No. 6,592,104 describes a scent dispensing method comprised of a cylindrical outer housing containing an inner scent containing housing and a battery powered fan. This prior art presents the shortcomings of any scent dispenser left at the site but with the added hazard of the hunter, through inadvertence or by intention, abandoning a battery powered device at the hunt site with the environmental hazard presented by the discarded battery. The present invention leaves no containers behind, does not overly contaminate the hunt site with the scent of the hunter lingering on the device or the scent of the device itself. The present invention leaves only the uncontaminated and disbursable scent substance in either a foam mass or particulate foam vapor form.

U.S. Pat. No. 6,550,689 describes an animal scent disbursing apparatus and method of use comprised of a staff, a housing unit, a liquid absorbing dragging material and a container of scent. The method of use is that as the staff is pressed onto the ground the action triggers a spraying device that sprays the scent onto the dragging material. The present invention overcomes the inherent shortcoming of this invention presented by the repellant scent of the hunter being disbursed along with the attractant scent and the scent painted along the path of the hunter operating the scent dispensing staff. Furthermore, the scent applied to the path does not attract the game to a single spot within the range of the hunter's blind or stand. The present invention has the added feature of permitting the hunter to determine the condition of air currents at the hunt site which U.S. Pat. No. 6,550,689 does not.

U.S. Pat. No. 6,460,487 describes a scent dispenser for a deer repellant device comprised of a dispenser that is capable of disbursing an attractant scent and, upon a deer coming into contact with the dispenser, delivering an electric shock to the animal. The invention, although intended ultimately for a different purpose than the attractant devices, presents the same shortcomings of the prior art in that the site is contaminated by the dispenser and the repellant scent of the person installing the device lingers with the device.

U.S. Patent 2003/0042329 describes the disbursal of a scent substance in the form of a foam string. The foam string has the disadvantage of becoming brittle and dry and losing its volatility quickly. Furthermore, in order to create the string, the scent substance must be mixed with acrylic resin, oils, inhibitors and isopropyl alcohol. The present invention contains no acrylic or plastic resin and has the added ability to be used to determine the condition and nature of air currents.

### DESCRIPTION OF THE INVENTION

The present invention relates to an improved scent substance in the form of a foam mass or a particulate foam vapor, a means for delivering the improved scent substance to the hunt site in a manner which eliminates many of the problems presented by the existing state of the art, the ability to adhere the foam mass form to substrate and the ability to use the particulate foam vapor form to disburse the attractant scent over great distance and determine the nature, direction and condition of the air currents at the hunt site.

Game is both attracted to and cautioned to remain from an area by the scent existing at the hunt site. A particular scent will attract game while another scent will repel game or will warn game to stay away from an area. The hunter desiring to lay a scent to attract game to an area is faced with the problem of determining the flow of air currents at the site and determining how to deliver the attracting scent to the area without at the same time unintentionally delivering to the area a scent, such as the scent of the hunter and the hunter's equipment, which will repel or warn the game away from the hunt site. The hunter carries a repellant scent and leaves a trail of such scent in his or her wake. That repellant scent is disbursed on air currents in whatever direction those currents are flowing. An object foreign to the hunt site, such as a can or container also carries a repellant scent. The hunter's repellant scent will linger with and be disbursed from any object that the hunter has handled, such as a can or container of scent substance.

The state of the art presently addresses only the problem of how to deliver the attracting scent, without addressing the latter problem, how to deliver the scent without introducing the repulsive scent of the hunter. The state of the art also does not provide a way to use the attractant substance to check the direction of the air currents.

An inherent nature of scent is that it disperses and fades over time. The scent of a hunter passing through an area in the afternoon will be a strong warning to game encountering that scent in the evening but not as strong a warning to game passing that way the next morning. The technique, known in the art, of dispensing urine from a container onto the hunt site has the disadvantage of being inseparably linked to the scent of the hunter doing the dispensing. Furthermore, the urine so dispensed will fade quickly by passing into the ground or by the natural disbursal of the scent over time. Therefore, the attractant and repellent are applied contemporaneously and are thus not effective.

To overcome the problem of rapid disbursal of the scent disbursed as urine poured onto the hunt site various slow dispersal solutions have been developed. All of these solutions however still present the problem of the repellant scent of the hunter and many also present the lingering repellant scent of the can or container itself, the scent of other materials, such as acrylic resin, that comprise the scent substance, and the scent of the hunter attached to the can or container by action of the hunter's manipulation of the container or housing. These devices being in one embodiment an absorbent material infused with urine are utilized by the hunter placing the material at the hunt site. The hunter is, in addition to leaving the scent infused material, leaving an object which the hunter has handled. By handling the object, the hunter is leaving some of the hunter's repellant scent along with the repellant scent of the item not normally occurring at the hunt site, specifically the absorbent material and whatever materials are attached thereto to permit the suspension of the material such as a hook or loop. These inventions present the further undesirable effect of the highly likely event that such materials will not be retrieved by the hunter at the conclusion of the hunt and thereby contribute to litter in hunting areas. Such activity not only being contrary to law also presents a hazard to wildlife which might be compelled to ingest such materials and further presents an aesthetic problem which detracts from enjoyment of such hunting areas and might jeopardize hunter access to such areas in response.

The present invention overcomes the problems and drawbacks of the present state of the art, presents an improved scent containing in the form of a foam mass or a particulate foam vapor form and allows the hunter to use the particulate vapor form to determine the direction of the air currents at the hunt site. The present invention allows the hunter to deliver a slow, time-released disbursal of attracting scent without the necessity for the hunter to leave with the foam the repellant scent of the hunter, the repellant scent of the scent disburser or the litter associated with the scent disburser.

The invention is a scent substance disbursal device that emits the substance in one of two forms, either a foam mass or a particulate foam vapor form and disbursal device that allows the hunter to spread a game attractant scent substance in a resilient and non-contaminated fashion on objects, such as the ground, a tree, rock or other substrate, at a hunting site. The invention solves problems presented by the existing state of the art and delivers an attractant scent substance superior to the present state of the art and superior to devices presently available and delivers a device that can determine the direction of the air currents.

The present invention relates to a scent substance disbursal device comprised of a scented liquid suspended in non-liquid foam and contained in a container from which the scent substance can be disbursed. The scent substance is disbursed from the container by depressing the nozzle actuator such that the contents, stored under pressure are disbursed from the disbursal tube onto the substrate of the hunter's choosing in either a foam mass or a particulate foam vapor form depending on the pressure of the contents of the can and the aperture of the actuator nozzle . By adjusting the pressure and the size of the actuator nozzle orifice, the scent substance can be disbursed in the particulate vapor form which floats on air currents. The particulate foam vapor particles can be carried for distances of 25 to 35 yards before settling to the ground or to the point where they can no longer be viewed by unaided human sight. In the foam mass form the scent substance is stored under appropriate pressure and coupled with an actuator nozzle orifice dimensioned to disburse the scent substance as a foam mass in such composition as to form a stable mound of foam that will neither run, drip, slump nor flow. The foam mass form has the feature of being adherent to the substrate regardless of the angle of the substrate. The foam is capable of being applied to and adhering to the horizontal, vertical side or underside of a rock or tree or the underside of a branch or overhanging rock. Such feature allows the foam mass form scent substance to be placed at a hunt site, exposed to air currents but sheltered somewhat from rain or other elements which would rapidly disburse the scent and scent substance. Scent substances are susceptible to rapid disbursal should they be exposed to water or falling rain. The advantage of the foam mass form scent substance having the adherent feature of the foam of the present invention is that the scent substance can be applied to a hunting site in a manner that protects the scent substance from rain and water.

The scent substance of the present invention is comprised of distilled water, scent or lure, surfactant, and a propellant of isobutene and propane. The scent substance is dispensed from a container by activation of the actuator nozzle. By varying the pressure of the propellant within the container and the size of the actuator nozzle, the scent substance is dispensed either as a foam mass form or as a particulate foam vapor.

The foam mass form is created under pressure that is less than the pressure used to create the particulate foam vapor. Pressurizing the container to a higher degree than used to produce the foam mass produces the particulate foam vapor which has the property of disbursing on air currents but while being of sufficient size to be visible to the hunter as it is disbursed. In addition to the precise pressure within the container, the size of the orifice of the actuator nozzle must be within a certain range in order to produce either foam mass form or particulate foam vapor. An orifice having a diameter within the range of 0.009-0.025 in. will produce particulate foam vapor. An orifice having a diameter within the range of 0.1-0.2 in. will produce foam mass. The contents of the container are maintained under pressure and pressurized before and to effect delivery of the scent substance at a pressure of between 25 and 35 pounds per square inch for dispensing as foam mass and between 45 and 55 for dispensing as particulate foam vapor.

### BRIEF DESCRIPTION OF THE SEVERAL VIEWS OF THE DRAWINGS

For further understanding of the nature and features of the present invention, reference should be made to the following detailed description, taken in conjunction with the accompanying drawings, in which like elements are given the reference numbers and wherein:

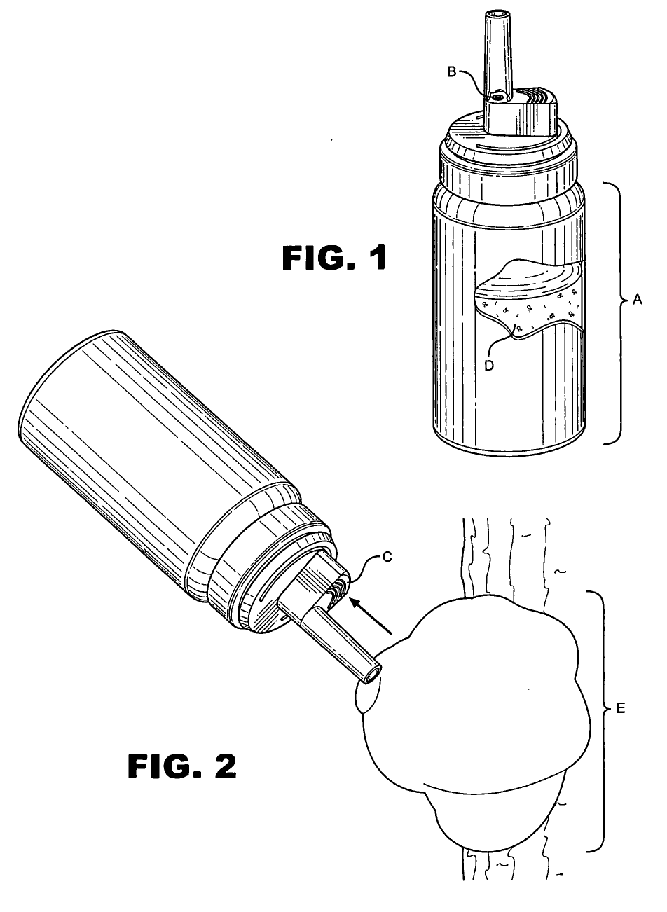

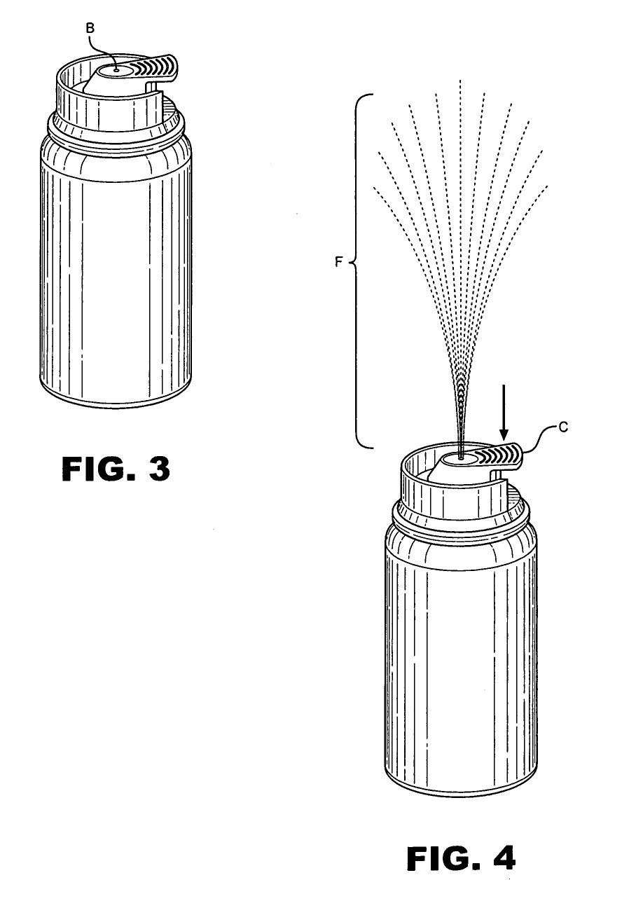

As set out in FIG. 1, the invention is comprised of a scent substance in a container (A). The scent substance is capable of being dispensed from the container (A) by activation of the actuator nozzle (B) by depressing on actuator tab(C, FIG. 2). The contents of the container are comprised of the scent, typically urine, distilled water, surfactant and a propellant of isobutene and propane (D). The contents of the container are maintained under pressure and pressurized before and to effect delivery of the scent substance at a pressure of between 25 and 35 pounds per square inch for dispensing as foam mass and between 45 and 55 for dispensing as particulate foam vapor by depressing the nozzle actuator tab(C). Upon such activation of the actuator nozzle, an amount of foam mass as set out in FIG. 2 (E) or particulate foam vapor as set out in FIG. 4 (F) is dispensed onto the substrate of the hunter's choosing or into the air to be carried by air currents. The actuator nozzle includes an orifice (B) in FIG. 1 and in FIG. 3 from which the foam mass or particulate foam vapor is expressed upon activation of the actuator nozzle by depressing on actuator tab(C) in FIG. 2 and FIG. 4. The orifice (B) in FIG. 3 has a diameter within the range of 0.009-0.025 in. to produce particulate foam vapor. The orifice (B) in FIG. 1 has a diameter within the range of 0.1-0.2 in. to produce foam mass.

As set out in FIG. 2, the scent substance in foam mass (E) is applied to the selected substrate without the hunter ever coming into contact with the substrate or the foam mass scent substance thus a pure attractant scent, free of hunter contaminate is applied to the substrate leaving the area as free of repellant hunter scent as possible. Furthermore, the invention is then removed by the hunter from the hunt site eliminating further or prolonged contamination of the site by either the scent of the container or the litter of the container.

As set out in FIG. 2 the scent containing is applied as a lump, mound or pile (E) adherent to the substrate. The feature of the invention that the foam mass scent substance has such density and adherent quality affords several advantages and improvements over the present state of the art. The adherent quality of the foam mass scent substance allows it to be applied in a manner that protects the foam mass scent substance from dissolution by rain or other elements. The adherent quality permits the foam mass scent substance to be applied in such a manner that the scent can be disbursed by air currents existing around the area of the application. The density of the foam mass scent substance allows the scent containing foam mass to be applied in a three dimensional lump, mound or pile (E).

As set out in FIG. 4, the scent substance under greater pressure and expelled from the smaller diameter orifice is disbursed as particulate foam vapor (F). The particulate foam vapor containing the scent is disbursed into and conveyed by air currents.

What is claimed is:

1. A game attracting scent disbursal device for dispensing and applying said game attracting scent substance in a foam mass to a substrate at a hunt site comprised of a container, a scent substance, and a nozzle actuator.

2. The game attracting scent disbursal device of claim 1 further comprised of a combination of distilled water, scent liquid such as animal urine, surfactant, and a propellant gas of isobutene and propane.

3. The game attracting scent disbursal device of claim 1 wherein the propellant is added in a volume sufficient to produce between 25 and 35 pounds per square inch pressure in the container device.

4. The game attracting scent disbursal device of claim 1 wherein the propellant is added in a volume sufficient to produce between 45 and 55 pounds per square inch pressure in the container device.

5. The game attracting scent disbursal device of claim 1 wherein the game attracting scent substance is comprised by volume of approximately 30-35% distilled water, 35-40% scent liquid, 2-5% surfactant, and 20-30% water.

6. The game attracting scent disbursal device of claim 1 wherein the actuator nozzle orifice has a diameter within the range of 0.1-0.2 in. to produce scent substance containing foam mass when actuated by depressing actuator tab.

7. The game attracting scent disbursal device of claim 1 wherein the actuator nozzle orifice has a diameter within the range of 0.009-0.025 in. to produce scent substance containing particulate foam vapor when actuated by depressing actuator tab.
